(19) United States
(12) Patent Application Publication
(10) Pub. No.: US 2019/0253152 A1
(43) Pub. Date: Aug. 15, 2019

(54) MULTI-RATE OPTICAL NETWORK

(71) Applicant: Nokia Solutions and Networks OY, Espoo (FI)

(72) Inventors: Vincent Houtsma, New Providence, NJ (US); Doutje van Veen, New Providence, NJ (US)

(73) Assignee: Nokia Solutions and Networks OY, Espoo (FI)

(21) Appl. No.: 15/896,783

(22) Filed: Feb. 14, 2018

(51) Int. Cl. H04B 10/61; H04B 10/54; H04L 7/00

(52) U.S. Cl. CPC H04B 10/616; H04B 10/612; H04L 7/0075; H04B 10/541

(57) ABSTRACT

A PON having an OLT configured to send downlink transmissions to ONUs using amplitude modulation and two symbol rates. An example ONU includes a clock-recovery circuit capable of continuous clock extraction from the received variable-rate modulated optical signal. The continuous clock extraction can be achieved, e.g., by (i) configuring the photodetector to convert the higher-rate portions of the received optical signal into transformed electrical waveforms while converting the lower-rate portions thereof into similar electrical waveforms and (ii) configuring the clock-recovery circuit to phase-align the clock signal with signal transitions in the resulting sequence of transformed and similar electrical waveforms. An ONU configured to operate in this manner can advantageously stay locked to the received data signal during transmissions at both symbol rates, without the need to reacquire the clock signal at each rate change and/or at the beginning of each packet intended for the host ONU.

### BACKGROUND

### Field

Various example embodiments relate to optical communication equipment and methods for optically communicating data.

### Description of the Related Art

This section introduces aspects that may help facilitate a better understanding of the disclosure. Accordingly, the statements of this section are to be read in this light and are not to be understood as admissions about what is in the prior art or what is not in the prior art.

In a telecommunication system, the speed of communication over a data channel can be measured in symbols per second, with the corresponding symbol-rate unit being the “baud.” The non-return-to-zero (NRZ) binary modulation format has two symbols (or levels), one for the binary “0” and one for the binary “1.” In the case of NRZ modulation, the symbol rate is the same as the bit rate, with the corresponding bit-rate unit being bits per second (bps). Other modulation formats can encode more than one bit in a symbol. In this situation, the symbol or baud rate differs from the data transmission rate, i.e., the bit rate.

In general, it is desirable to achieve a relatively high data rate at a relatively low bit-error rate.

### SUMMARY OF SOME SPECIFIC EMBODIMENTS

Disclosed herein are various embodiments of a passive optical network (PON) having an optical line terminal (OLT) configured to send downlink transmissions to a plurality of optical network units (ONUs) using amplitude modulation and at least two different symbol rates. An optical receiver deployed at an ONU has a clock-recovery circuit capable of substantially continuous clock extraction from the received variable-rate modulated optical signal, at both rates and through rate changes. In an example embodiment, the continuous clock extraction is achieved by (i) configuring the photodetector of the optical receiver to convert the higher-rate portions of the received optical signal into transformed electrical waveforms while converting the lower-rate portions thereof into electrical waveforms that substantially trace the optical waveforms and (ii) configuring the clock-recovery circuit to phase-align the generated clock signal with signal transitions in the resulting sequence of the transformed and tracing electrical waveforms. An optical receiver configured to operate in this manner can advantageously stay locked to the received data signal during downlink transmissions at both symbol rates, without the need to reacquire the clock signal at each rate change and/or at the beginning of each data packet intended for the host ONU.

Some embodiments provide an optical receiver that is configurable, with one configuration thereof being suitable for data recovery from the higher-rate portions of the received optical signal, and another configuration thereof being suitable for data recovery from the lower-rate portions of the received optical signal.

According to an example embodiment, provided is an apparatus comprising an optical receiver configured to receive an optical input signal modulated with data, wherein the optical receiver comprises: (i) an optical-to-electrical converter configured to: generate a first amplitude-modulated electrical signal in response to a first amplitude-modulated portion of the optical input signal, the first amplitude-modulated portion having a first symbol rate; and generate a second amplitude-modulated electrical signal in response to a second amplitude-modulated portion of the optical input signal, the second amplitude-modulated portion having a second symbol rate that is greater than the first symbol rate; and (ii) a clock-recovery circuit configured to generate a first clock signal by processing a sequence of said first and second amplitude-modulated electrical signals to phase-align the first clock signal with signal transitions therein.

According to another example embodiment, provided is an apparatus comprising an optical receiver configured to receive an optical input signal modulated with data, wherein the optical receiver comprises: (i) an optical-to-electrical converter configured to: generate a non-return-to-zero (NRZ)-modulated electrical signal in response to a first NRZ-modulated portion of the optical input signal, the first NRZ-modulated portion having a first symbol rate; and generate a duobinary electrical signal in response to a second NRZ-modulated portion of the optical input signal, the second NRZ-modulated portion having a second symbol rate that is greater than the first symbol rate; and (ii) a clock-recovery circuit configured to generate a first clock signal by processing a sequence of said NRZ-modulated and duobinary electrical signals to phase-align the first clock signal with signal transitions therein.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 shows a block diagram of a passive-optical-network (PON) system according to an embodiment;

FIG. 2 shows a block diagram of an optical transmitter that can be used in the PON system of FIG. 1 according to an embodiment;

FIG. 3 shows an example temporal structure of an optical output signal generated by the optical transmitter of FIG. 2 according to an embodiment;

FIG. 4 shows a block diagram of an optical receiver that can be used in the PON system of FIG. 1 according to an embodiment;

FIGS. 5A-5B graphically show example eye diagrams of an optical signal received by the optical receiver of FIG. 4 according to an embodiment;

FIG. 6 graphically shows an example transfer function of an optical-to-electrical (O/E) converter that can be used in the optical receiver of FIG. 4 according to an embodiment

FIGS. 7A-7B graphically show example eye diagrams of an electrical signal generated in the optical receiver of FIG. 4 in response to the optical signal shown in FIGS. 5A-5B according to an embodiment;

FIG. 8 shows a block diagram of a clock-recovery circuit that can be used in the optical receiver of FIG. 4 according to an embodiment;

FIG. 9 shows a block diagram of a signal decoder that can be used in the optical receiver of FIG. 4 according to an embodiment; and

FIGS. 10A-10C show truth tables that illustrate example configurations of the signal decoder of FIG. 9 according to an embodiment.

### DETAILED DESCRIPTION

Some embodiments disclosed herein may benefit from the use of at least some features disclosed in U.S. patent application Ser. Nos. 15/696,939, 15/858,449, and 15/885,385, all of which are incorporated herein by reference in their entirety.

A passive optical network (PON) typically has a point-to-multipoint architecture in which passive optical splitters are used to enable a single optical transmitter to broadcast data transmissions to multiple optical receivers. An example PON includes an optical line terminal (OLT) at the service provider's central office (CO) and a plurality of optical network units (ONUs) near or at the individual end users. The ONUs are typically connected to the OLT by way of one or more passive optical splitters. Downlink signals are usually broadcast to all ONUs or at least a group of ONUs. Uplink signals are routed using a multiple access protocol, e.g., usually time division multiple access (TDMA). A PON is capable of advantageously reducing the amount of fiber, CO equipment, and active traffic-management equipment, e.g., compared to that required for point-to-point architectures.

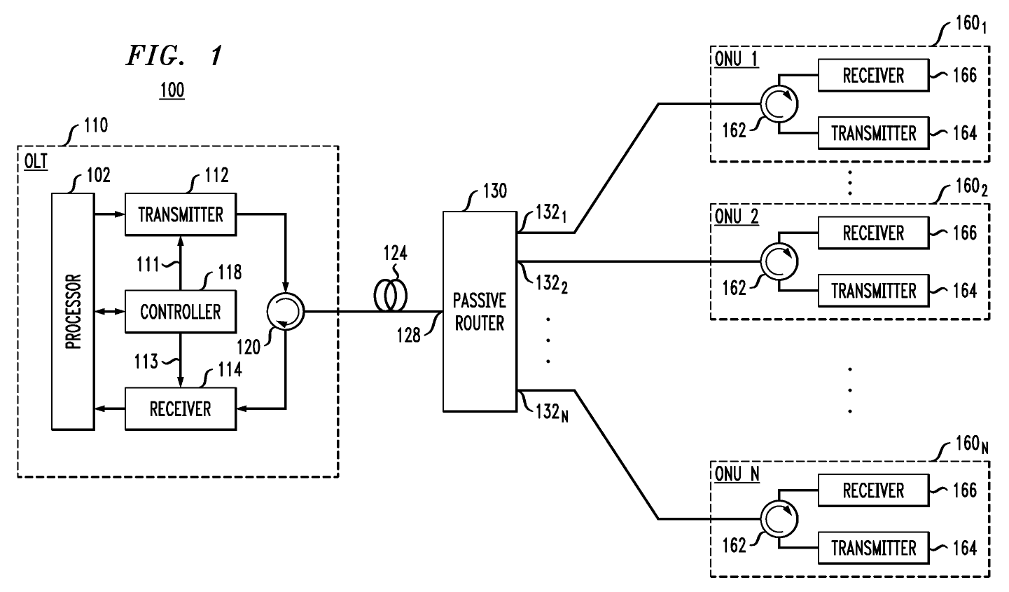

FIG. 1 shows a block diagram of a PON system 100 according to an embodiment. System 100 has an OLT 110 configured to communicate with ONUs 160₁-160_{N}. In an example embodiment, the number N can be in the range from 2 to 256. In some embodiments, ONUs 160₁-160_{N} can be configured to use (nominally) the same carrier wavelength for uplink transmissions. In some other embodiments, ONUs 160₁-160_{N} can be configured to use different respective carrier wavelengths for uplink transmissions.

OLT 110 comprises an optical transmitter 112 and an optical receiver 114, both coupled, by way of an optical circulator 120 or other suitable directional optical coupler, to an optical fiber 124. Operation, functions, and configurations of transmitter 112 and receiver 114 can be managed and controlled using control signals 111 and 113 generated by an electronic controller 118. A processor 102 that is operatively coupled to transmitter 112, receiver 114, and controller 118 can be used for signal and data processing and, optionally, for supporting some functions of the controller. In an example embodiment, optical fiber 124 can have a length between about 1 km and about 40 km.

Transmitter 112 is configured to broadcast downlink signals to ONUs 160₁-160_{N} using one or more downlink carrier wavelengths. Receiver 114 is configured to receive uplink signals from ONUs 160₁-160_{N} transmitted using one or more uplink carrier wavelengths. Time-division multiplexing, e.g., by way of a suitable TDMA protocol executed using controller 118, can be used to prevent collisions, at receiver 114, between the uplink signals generated by different ONUs 160.

Optical fiber 124 connects OLT 110 to a passive router 130. Depending on the embodiment, router 130 can be implemented using: (i) a (1×N) passive optical splitter/combiner; (ii) a passive wavelength router (e.g., an arrayed waveguide grating, AWG); or (iii) any suitable combination of wavelength-insensitive and/or wavelength-sensitive passive optical elements. In an example embodiment, router 130 has (N+1) optical ports, including a single port 128 at its first or uplink side and a set of N ports 132₁-132_{N} at its second or downlink side. Herein, the term “side” is used in an abstract sense to indicate “uplink” or “downlink” directions rather than in a physical-orientation sense. Port 128 is internally optically connected to each of ports 132₁-132_{N}. Port 128 is externally optically connected to optical fiber 124 as indicated in FIG. 1. Ports 132₁-132_{N} are externally optically connected to ONUs 160₁-160_{N}, respectively, e.g., via optical fibers or more complex, passive optical-fiber networks, as further indicated in FIG. 1. Example devices that can be used to implement router 130 are disclosed, e.g., in the above-cited U.S. patent application Ser. No. 15/696,939 and U.S. Pat. No. 8,923,672.

In an example embodiment, each of ONUs 160₁-160_{N} includes a respective optical circulator 162 or other suitable directional optical coupler, a respective optical transmitter 164, and a respective optical receiver 166. Optical circulator 162 is configured to (i) direct downlink signals received from router 130 to optical receiver 166 and (ii) direct uplink signals from optical transmitter 164 to router 130.

In some embodiments, system 100 can be configured to operate such that all downlink signals are spectrally located in a spectral band near 1.55 μm, and all uplink signals are spectrally located in a spectral band near 1.3 μm, or vice versa. In such embodiments, all or some of optical circulators 120 and 162 may be replaced by respective optical band-pass or dichroic optical filters.

While FIG. 1 illustrates a PON with a single passive optical router 130, various possible embodiments are not so limited and may have more-complex PON architectures, e.g., having multiple passive optical routers and tree-like topologies.

In an example embodiment, different ONUs 160 may be located at different respective distances from OLT 110 and/or router 130 and be connected thereto such that the corresponding optical paths through system 100 have significantly different optical insertion losses. As a result, the same optical signal broadcast by OLT 110 may be received by different ONUs 160 with different respective levels of attenuation and different respective signal-to-noise ratios (SNRs). For example, the SNR values corresponding to different ONUs 160 may fall into a range between SNR₁ and SNR₂, where SNR₁>SNR₂. In some embodiments, the values of SNR₁ and SNR₂ can be such that some of the optical paths through system 100 can support a higher bit or symbol rate than the other optical paths therethrough.

Example embodiments disclosed herein enable OLT 110 to use at least two different bit or symbol rates for downlink transmissions, the higher of the two rates being used to transmit data to ONUs 160 that “see” relatively high SNRs, and the lower of the two rates being used to transmit data to ONUs 160 that “see” relatively low SNRs. In various embodiments, different ones of ONUs 160₁-160_{N} may be selected from the following set of devices: (i) an ONU capable of detecting and decoding optical signals having a first bit or symbol rate; (ii) an ONU capable of detecting and decoding optical signals having a second bit or symbol rate; and (iii) an ONU that is configurable to detect and decode optical signals having a selected one of the first and second bit or symbol rates.

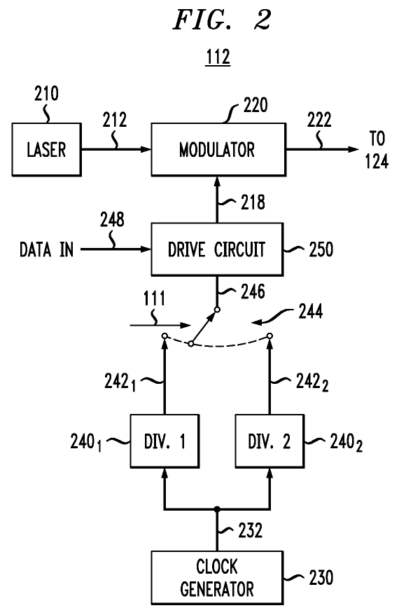

Certain operating methods and optoelectronic circuits and devices that can be used in various embodiments of system 100 for multi-rate downlink transmissions are described in more detail below in reference to FIGS. 2-10. For illustration purposes and without any implied limitations, example embodiments are described below in reference to NRZ modulation and bit rates R₁=25 Gbps and R₂=50 Gbps. A person of ordinary skill in the art will understand how to make and use other embodiments in which other suitable modulation formats and/or other bit and/or symbol rates R₁ and R₂ are used. Example alternative modulation formats include but are not limited to various forms of pulse-amplitude modulation (PAM) and polybinary modulation. A person of ordinary skill in the art will also understand that NRZ modulation is a form of PAM and is sometimes referred to as PAM-2. Other examples of pulse-amplitude modulation include PAM-4, PAM-8, etc.

FIG. 2 shows a block diagram of optical transmitter 112 according to an embodiment. Transmitter 112 comprises an optical modulator 220 configured to generate a modulated optical output signal 222 in response to an electrical drive signal 218 received from a drive circuit 250. An optical carrier wave 212 that is modulated by optical modulator 220 is supplied thereto by a laser source 210.

FIG. 3 shows an example temporal structure of optical signal 222 according to an embodiment. Signal 222 comprises a sequence of data frames 302, only five of which, labeled 302₁-302₅, are shown in FIG. 3 for illustration purposes. Some data frames 302 have a first symbol rate (e.g., R₁), and some other data frames 302 have a second symbol rate (e.g., R₂) that is different from the first bit rate. For example, the first and second symbol rates R₁ and R₂ can be 25 Gbaud and 50 Gbaud, respectively.

In an example embodiment, different data frames 302 may be intended for different respective ONUs 160, even though the corresponding optical signal 222 is broadcast and can typically be received by at least a group of ONUs 160. For example, data frame 302₁ may be intended for ONU 160₁. Data frame 302₂ may be intended for ONU 160₂. Data frame 302₃ may be intended for ONU 160_{N}, etc. The intended destination(s) of different data frames 302 may be indicated in the frame header, e.g., as known in the pertinent art.

The duration of different data frames 302 may be the same or different, or may vary as needed to accommodate different traffic volumes directed to different ONUs 160. The order in which data frames 302 intended for different ONUs 160 are transmitted may be set according to a fixed (e.g., round-robin) schedule or may be determined dynamically (e.g., based on the corresponding communication needs or traffic volumes).

Referring back to FIG. 2, drive circuit 250 operates to generate electrical drive signal 218 that causes optical modulator 220 to generate optical signal 222 having the above-indicated characteristics. In an example embodiment, electrical drive signal 218 may have two voltage levels configured to cause optical output signal 222 to be an ON/OFF NRZ signal. For example, when electrical drive signal 218 is at the first voltage level, substantially all of the light of optical carrier wave 212 is blocked by optical modulator 220, thereby causing optical signal 222 to receive substantially no light from laser source 210 in the corresponding time slot. On the other hand, when electrical drive signal 218 is at the second voltage level, optical modulator 220 operates to transfer most of the light of optical carrier wave 212 to optical output signal 222 in the corresponding time slot.

The input bit of an electrical data signal 248 received by drive circuit 250 determines which voltage level electrical drive signal 218 is going to have in the corresponding time slot. For example, if the received input bit is a binary “0,” then drive circuit 250 generates the first voltage level for electrical drive signal 218 in the corresponding time slot. On the other hand, if the received input bit is a binary “1,” then drive circuit 250 generates the second voltage level for electrical drive signal 218 in the corresponding time slot.

Drive circuit 250 is configured to use a clock signal received at a clock port 246 thereof to time the transitions in electrical drive signal 218 between the first and second levels. A clock-selector switch 244 can apply to clock port 246 either a clock signal 242₁ or a clock signal 242₂ in response to control signal 111 (also see FIG. 1). For example, to configure transmitter 112 to generate data frame 302₁, 302₃, or 302₄ (see FIG. 3), control signal 111 may be generated by controller 118 in a manner that configures clock-selector switch 244 to apply clock signal 242₁ to clock port 246. Similarly, to configure transmitter 112 to generate data frame 302₂ or 302₅ (also see FIG. 3), control signal 111 may be generated by controller 118 in a manner that configures clock-selector switch 244 to apply clock signal 242₂ to clock port 246.

Transmitter 112 includes a clock generator 230 and frequency dividers 240₁ and 240₂ that are used to generate clock signals 242₁ and 242₂ in a manner that causes the two clock signals to be phase-locked to one another. More specifically, clock generator 230 operates to generate a master clock signal 232 and apply respective copies thereof to frequency dividers 240₁ and 240₂. Frequency divider 240₁ operates to divide the frequency of master clock signal 232 by a first division factor, thereby generating clock signal 242₁. Frequency divider 240₂ similarly operates to divide the frequency of master clock signal 232 by a second division factor that is different from the first division factor, thereby generating clock signal 242₂.

In some embodiments, each of the first and second division factors can be an integer.

In some embodiments, fractional frequency dividers 240₁ and 240₂ can be used.

In some embodiments, one of frequency dividers 240₁ and 240₂ can be absent. For example, if frequency divider 240₂ is absent, then master clock signal 232 can be applied directly to clock-selector switch 244 in lieu of clock signal 242₂. A functionally equivalent configuration can also be achieved by configuring frequency divider 240₂ to apply a division factor of one.

In some embodiments, one or each of frequency dividers 240₁ and 240₂ can be replaced or supplemented by a suitable frequency multiplier.

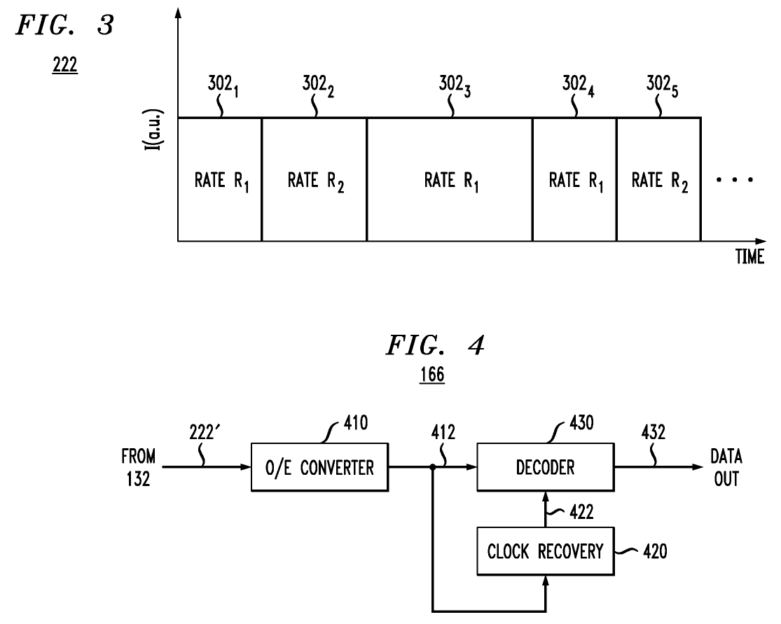

FIG. 4 shows a block diagram of an optical receiver 166 (FIG. 1) according to an embodiment. As indicated above, optical receiver 166 is located at an ONU 160 and is configured to recover the data transmitted using optical signal 222 and carried by the frame(s) 302 (FIG. 3) intended for that particular ONU. During transmission through system 100 from OLT 110 to receiver 166, optical signal 222 is attenuated and possibly distorted, which is indicated in FIG. 4 by labeling the received signal as 222′. The recovered data are directed to external circuits by way of an output data signal 432.

In an example embodiment, optical receiver 166 comprises an optical-to-electrical (O/E) converter (e.g., comprising a photodiode) 410, a clock recovery circuit 420, and a signal decoder 430 operatively connected as indicated in FIG. 4. O/E converter 410 operates to convert optical signal 222′ into a corresponding electrical signal 412. Clock recovery circuit 420 operates to process electrical signal 412, e.g., as further described below, to generate a clock signal 422 that is phase locked to clock signals 232, 242₁, and 242₂ (FIG. 2). In some embodiments, clock signal 422 may also be frequency locked to one of clock signals 232, 242₁, and 242₂. Decoder 430 operates to: (i) sample electrical signal 412 at times determined using clock signal 422, and (ii) convert the resulting signal samples into output data for signal 432.

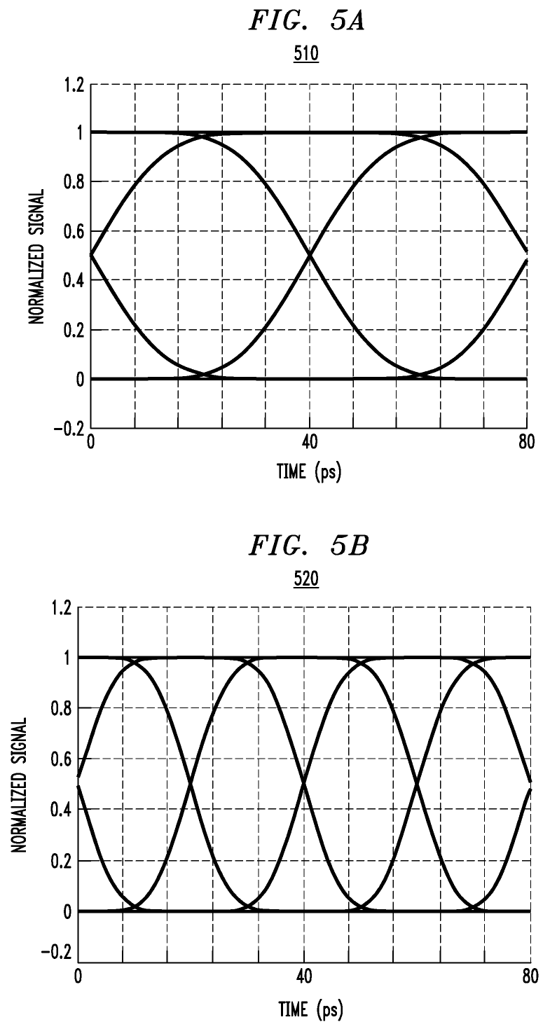

Example embodiments of O/E converter 410, clock recovery circuit 420, and signal decoder 430 and their functions and operation are described in more detail below in reference to FIGS. 5-10.

FIGS. 5A-5B graphically show example eye diagrams of optical signal 222′ (FIG. 4) according to an embodiment. More specifically, FIG. 5A graphically shows an example eye diagram of a portion 510 of optical signal 222′ corresponding to a data frame 302 (FIG. 3) generated using NRZ modulation at the bit rate R₁=25 Gbps. FIG. 5B similarly graphically shows an example eye diagram of a portion 520 of optical signal 222′ corresponding to a data frame 302 (FIG. 3) generated using NRZ modulation at the bit rate R₂=50 Gbps (i.e., R₂=2R₁). As already indicated above, optical signal 222′ carries a sequence of data frames 302, wherein some data frames include waveforms whose eye diagrams are similar to that of portion 510 (FIG. 5A), and some other data frames include waveforms whose eye diagrams are similar to that of portion 520 (FIG. 5B).

A person of ordinary skill in the art will appreciate that extraction of a proper clock signal from optical signal 222′ whose symbol rate varies over time, e.g., in the above-indicated manner, can be challenging. This problem is addressed herein by embodiments in which NRZ-to-duobinary signal conversion is used to enable continuous clock extraction from the received variable-rate optical NRZ signal. Some embodiments provide an optical receiver 166 that is configurable, with one configuration thereof being suitable for data recovery from signal portions having the lower rate, and another configuration thereof being suitable for data recovery from signal portions having the higher rate.

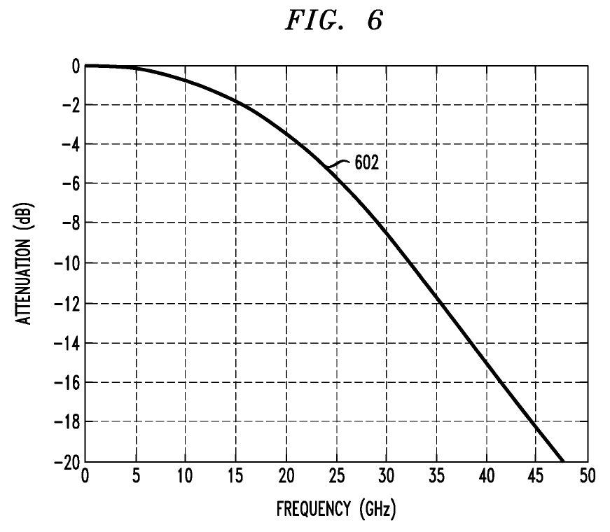

FIG. 6 graphically shows an example transfer function 602 of O/E converter 410 (FIG. 4) according to an embodiment. Transfer function 602 is quantitatively similar to that of a low-pass filter (LPF). As shown, transfer function 602 has a 3-dB attenuation point at ca. 18 GHz. In alternative embodiments, the 3-dB attenuation point can be located anywhere between ca. 10 GHz and ca. 20 GHz. In general, embodiments of O/E converter 410 can be designed and/or configured to have an LPF transfer function whose 3-dB attenuation point is located between ca. 20% and 40% of the higher of the two bit rates expressed in Hz.

In various embodiments, O/E converter 410 having transfer function 602 can be implemented using circuit components selected from the following nonexclusive list: (i) a photodiode, such as an avalanche photodiode; (ii) an electrical amplifier, such as a transimpedance amplifier; and (iii) an electrical filter, such as an equalizing or low-pass filter. Some embodiments of O/E converter 410 may benefit form the use of circuit elements disclosed in U.S. Pat. No. 7,508,882, which is incorporated herein by reference in its entirety.

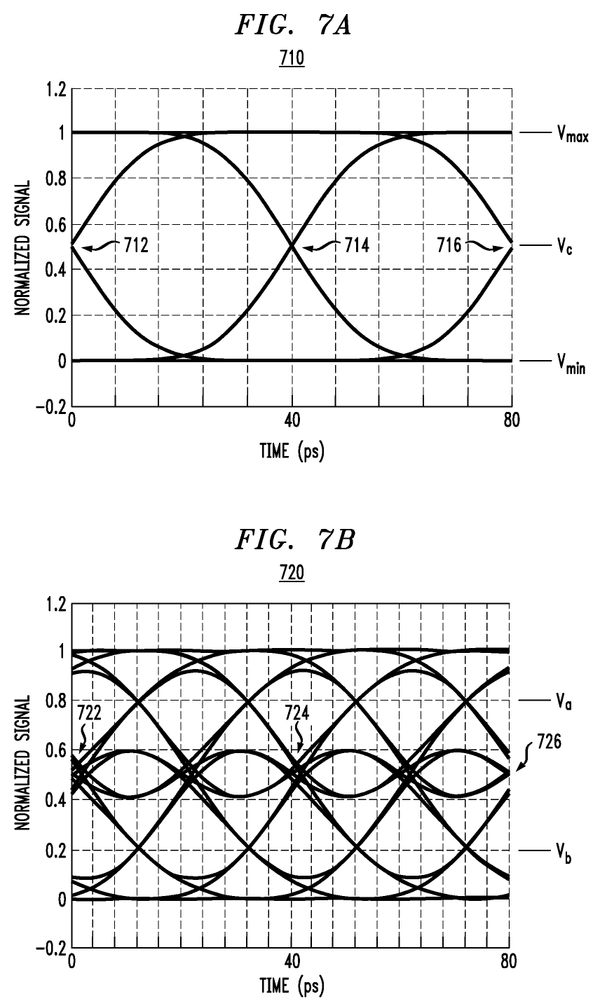

FIGS. 7A-7B graphically show example eye diagrams of electrical signal 412 (FIG. 4) according to an embodiment. More specifically, FIG. 7A graphically shows an example eye diagram of a portion 710 of electrical signal 412 generated by O/E converter 410 having transfer function 602 (FIG. 6) in response to receiving portion 510 (FIG. 5A) of optical signal 222′. FIG. 7B graphically shows an example eye diagram of a portion 720 of electrical signal 412 generated by O/E converter 410 having transfer function 602 (FIG. 6) in response to receiving portion 520 (FIG. 5B) of optical signal 222′.

Inspection of the eye diagrams shown in FIGS. 7A-7B reveals that O/E converter 410 having the above-described characteristics operates to: (i) convert an optical NRZ signal having a bit rate of 25 Gbps into a corresponding electrical NRZ signal; and (ii) convert an optical NRZ signal having a bit rate of 50 Gbps into a corresponding electrical duobinary signal. As known in the modulation arts, a duobinary signal encodes data using three signal levels, which are often referred to as the +1, 0, and −1 levels, respectively. A duobinary signal can be generated from a corresponding binary signal using known deterministic transformation rules. Due to the properties of the transformation, a duobinary signal has no direct transitions between the +1 and −1 levels in two consecutive time slots, which enables recovery of a half-rate clock as further explained below. Direct transitions in a duobinary signal only occur between (i) the 0 and +1 levels and (ii) the 0 and −1 levels. Reconstruction of the original binary signal from the corresponding duobinary signal is also deterministic and relatively straightforward. Although both binary and duobinary signals carry the same information, the bandwidth of the duobinary signal may be reduced by a factor of two compared to that of the binary signal at the expense of the SNR.

In the eye diagram of FIG. 7B, the +1, 0, and −1 levels of the corresponding duobinary signal are located at the normalized-signal levels of approximately 1, 0.5, and 0, respectively.

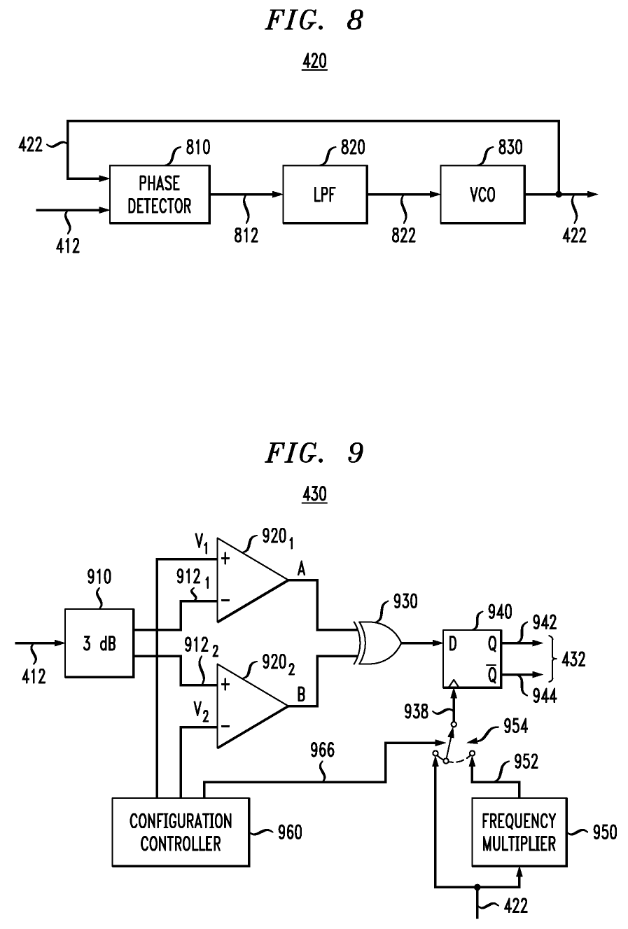

It can also be noted that, on average, the electrical signals corresponding to the eye diagrams of FIGS. 7A-7B have the same number of signal transitions through the normalized-signal level of 0.5. For example, the eye diagram of FIG. 7A has transition nodes 712, 714, and 716 located at approximately 0, 40, and 80 ps, respectively. The eye diagram of FIG. 7B similarly has transition nodes 722, 724, and 726 located at approximately 0, 40, and 80 ps, respectively. These characteristics of electrical signal 412 can be used to generate clock signal 422, e.g., as described below in reference to FIG. 8.

In an alternative embodiment, O/E converter 410 and/or a portion thereof that is used to feed an electrical input signal into clock-recovery circuit in lieu of signal 412 (see FIG. 4) can be designed to have a transfer function that is suitable for the particular modulation format (e.g., PAM-4) used for downlink data transmissions in system 100. In such embodiments, the transfer function can be such as to cause O/E converter 410 to: (i) convert the higher-rate portions of the received optical signal into transformed electrical waveforms; and (ii) convert the lower-rate portions of the received optical signal into electrical waveforms that substantially trace the optical waveforms. The transformed electrical waveforms can be, e.g., such as to have, on average, the same number of signal transitions through a particular signal level as the electrical waveforms that trace the lower-rate optical waveforms.

FIG. 8 shows a block diagram of clock-recovery circuit 420 (FIG. 4) according to an embodiment. As shown, circuit 420 comprises a phase detector 810, a low-pass filter (LPF) 820, and a voltage-controlled oscillator (VCO) 830 operatively connected as indicated in FIG. 8.

Phase detector 810 is configured to receive (i) electrical signal 412 generated by O/E converter 410 and (ii) a copy of clock signal 422 as a feedback from VCO 830. When VCO 830 receives a zero-voltage input signal 822, the VCO operates to generate clock signal 422 the nominal frequency of which corresponds to bit rate R₁. For example, if R₁=25 Gbps, then this nominal frequency is 25 GHz. When the voltage of input signal 822 is not zero, VCO 830 operates to shift the frequency of clock signal 422 with respect to the nominal frequency by an amount that is proportional to the voltage of input signal 822. Depending on the sign of the voltage, the frequency shift can be positive or negative, thereby increasing or decreasing the frequency of clock signal 422 accordingly.

As already indicated above, electrical signal 412 can have some signal portions that are analogous to portion 710 (FIG. 7A) and some signal portions that are analogous to portion 720 (FIG. 7B). However, both signal-portion types have similarly timed signal transitions through the normalized-signal level of 0.5 (see, e.g., signal-transition nodes 712, 714, and 716 in FIG. 7A and signal-transition nodes 722, 724, and 726 in FIG. 7B). Phase detector 810 is configured to use this property of electrical signal 412 to enable circuit 420 to continuously generate clock signal 422 in a manner that: (i) is insensitive to the order in which the different signal-portion types appear in electrical signal 422 and (ii) causes the generated clock signal 422 to be continuously phase and frequency locked, e.g., to clock signal 242₁.

In an example embodiment, phase detector 810 operates to: (i) detect a transition in electrical signal 412 through the normalized-signal level of 0.5; (ii) determine the time difference between the detected transition and the rising edge of clock signal 422 in the corresponding time slot; (iii) use the determined time difference to calculate the corresponding phase error; and (iv) generate a phase-error signal 812 such that the voltage thereof in the corresponding time slot is proportional to the phase error. Depending on the sign of the phase error, phase-error signal 812 can be positive or negative.

Phase-error signal 812 generated in the above-indicated manner typically varies from time slot to time slot. Low-pass filter 820 operates to average the voltage variations of phase-error signal 812, thereby generating an averaged phase-error signal, which is then applied to VCO 830 by way of input signal 822. In various embodiments, the frequency characteristics of low-pass filter 820 can be appropriately selected to provide adequate phase-error averaging. For example, in some embodiments, the effective averaging time provided by low-pass filter 820 can be on the order of one hundred signaling time slots.

In response to the received averaged phase-error signal 822, VCO 830 operates to continuously adjust the frequency of clock signal 422, thereby generating a clock signal that continuously tracks and is phase-locked to the data clock of optical signal 222.

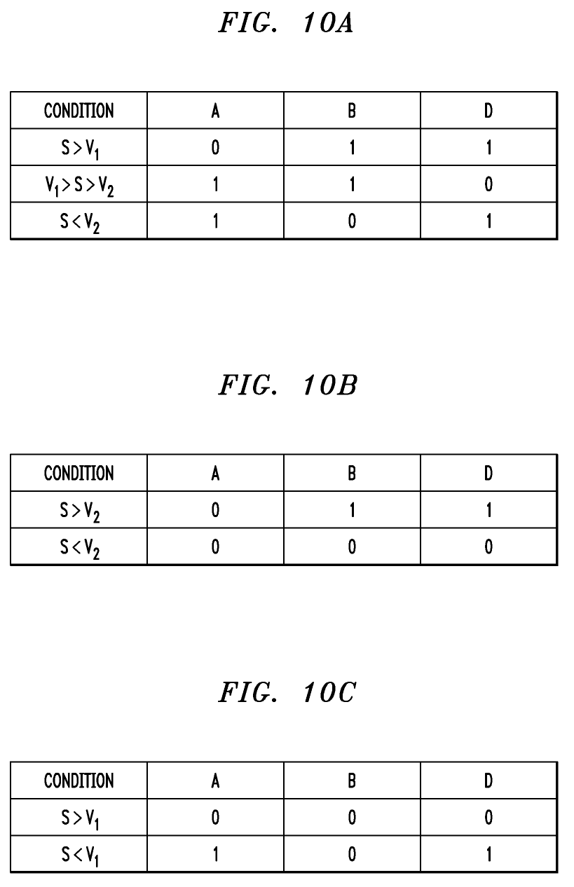

FIG. 9 shows a block diagram of signal decoder 430 according to an embodiment. As further explained below in reference to FIGS. 10A-10C, this embodiment of decoder 430 is configurable in a manner that enables the use of the corresponding optical receiver 166 both in an ONU 160 connected to receive downlink transmissions having the bit rate R₁ and in an ONU 160 connected to receive downlink transmissions having the bit rate R₂. A person of ordinary skill in the art will understand that alternative embodiments of decoder 430 are also possible, in which embodiments the decoder has a fixed configuration that enables the use of the corresponding optical receiver 166 either in an ONU 160 connected to receive downlink transmissions having the bit rate R₁ or in an ONU 160 connected to receive downlink transmissions having the bit rate R₂.

Decoder 430 comprises a splitter 910 configured to split electrical signal 412 into two portions (e.g., attenuated copies), which are labeled in FIG. 9 using the reference numerals 912₁ and 912₂. In the shown embodiment, splitter 910 is a 3-dB splitter. In alternative embodiments, other suitable signal splitters can also be used.

Decoder 430 further comprises comparators 920₁ and 920₂. A comparator 920 is a three-port device having two inputs and one output. The two inputs of the comparator are hereafter referred to as the non-inverting input (labeled using the “+” sign) and the inverting input (labeled using the “−” sign), respectively. Depending on which of the signals applied to the inputs of comparator 920 has a higher voltage, the comparator generates at the output thereof either a binary one or a binary zero.

Signal 912₁ is applied to the inverting input of comparator 920₁. Signal 912₂ is applied to the non-inverting input of comparator 920₂. The non-inverting input of comparator 920₁ is connected to receive a first reference voltage (V₁) from a configuration controller 960. The inverting input of comparator 920₂ is connected to receive a second reference voltage (V₂) from configuration controller 960. The outputs of comparators 920₁ and 920₂, which are labeled in FIG. 9 using the reference labels A and B, respectively, are connected to the inputs of an exclusive-OR (XOR) gate 930. The output of XOR gate 930 is connected to the data input (labeled D) of a flip-flop 940. Flip-flop 940 is a conventional data flip-flop that has two data outputs: a non-inverting output Q and an inverting output Q̅. Depending on the reference voltages V₁ and V₂ applied to comparators 920₁ and 920₂, either a data signal 942 generated at non-inverting output Q or a data signal 944 generated at inverting output Q̅ can be used as output data signal 432.

Flip-flop 940 is clocked by rising edges of a clock signal received at a clock input 938 thereof. A clock-selector switch 954 can apply to clock input 938 either clock signal 422 generated by clock recovery circuit 420 (FIG. 8) or a clock signal 952 generated by a frequency multiplier 950 by multiplying the frequency of clock signal 422. The state of clock-selector switch 954 can be controlled using a control signal 966 generated by configuration controller 960.

In an example embodiment, frequency multiplier 950 is configured to generate clock signal 952 by multiplying the frequency of clock signal 422 by a factor of two.

In some embodiments, frequency multiplier 950 can be configured to generate clock signal 952 by multiplying the frequency of clock signal 422 by a factor of four. In such embodiments, some additional processing of data signals 942 and 944 needs to performed to generate output data signal 432. An example of such additional signal processing is described, e.g., in U.S. Pat. No. 7,613,402, which is incorporated herein by reference in its entirety.

FIGS. 10A-10C show truth tables that illustrate three example configurations of decoder 430 (FIG. 9) according to an embodiment. In each of the truth tables, S denotes signals 912₁ and 912₂, which are assumed to be equal to (copies of) one another. The first column lists different signal conditions. The second, third, and fourth columns list the corresponding binary values generated at output A of comparator 920₁, output B of comparator 920₂, and data input D of flip-flop 940, respectively.

FIG. 10A shows the truth table corresponding to a first example configuration of decoder 430 in which the decoder operates as a duobinary-signal decoder. This configuration can be obtained by configuring controller 960 to set the following reference voltages: V₁=Vₐ and V₂=V_{b} (see FIG. 7B). Controller 960 is further configured to generate control signal 966 that causes clock-selector switch 954 to apply clock signal 952 to clock input 938 of flip-flop 940. In this configuration, data signal 942 is used as output data signal 432.

The approximate values of Vₐ and V_{b} are graphically indicated in FIG. 7B. For example, the Vₐ value corresponds to the normalized-signal level of ˜0.8. The V_{b} value corresponds to the normalized-signal level of ˜0.2. A person of ordinary skill in the art will understand that the values of Vₐ and V_{b} can be optimized for optimal performance, e.g., based on the characteristics of the actual eye diagram of the duobinary signal that is being decoded.

FIG. 10B shows the truth table corresponding to a second example configuration of decoder 430 in which the decoder operates as a binary-signal decoder. This configuration can be obtained by configuring controller 960 to set the following reference voltages: V₁<Vₘᵢₙ and V₂=V_{c} (see FIG. 7A). Controller 960 is further configured to generate control signal 966 that causes clock-selector switch 954 to apply clock signal 422 to clock input 938 of flip-flop 940. In this configuration, data signal 942 is used as output data signal 432.

The approximate values of Vₘᵢₙ and V_{c} are graphically indicated in FIG. 7A. For example, the Vₘᵢₙ value corresponds to the normalized-signal level of 0. The value of V₁ can be set, e.g., at the normalized-signal level of approximately ˜0.2 to keep output A of comparator 920₁ at zero at all times. The V_{c} value corresponds to the normalized-signal level of ˜0.5. A person of ordinary skill in the art will understand that the values of V₁ and V_{c} can be optimized for optimal performance based on the characteristics of the actual eye diagram of the binary signal that is being decoded.

FIG. 10C shows the truth table corresponding to a third example configuration of decoder 430 in which the decoder operates as a binary-signal decoder. This configuration can be obtained by configuring controller 960 to set the following reference voltages: V₂>Vₘₐₓ and V₁=V_{c} (also see FIG. 7A). Controller 960 is further configured to generate control signal 966 that causes clock-selector switch 954 to apply clock signal 422 to clock input 938 of flip-flop 940. In this configuration, data signal 944 is used as output data signal 432.

The approximate values of Vₘₐₓ and V_{c} are indicated in FIG. 7A. For example, the Vₘₐₓ value corresponds to the normalized-signal level of 1. The value of V₂ can be set, e.g., at the normalized-signal level of 1.2 to keep output B of comparator 920₂ at zero at all times. As already indicated above, the V_{c} value corresponds to the normalized-signal level of ˜0.5. A person of ordinary skill in the art will understand that the values of V₂ and V_{c} can be optimized for optimal performance based on the characteristics of the actual eye diagram of the binary signal that is being decoded.

According to an example embodiment disclosed above, e.g., in the summary section and/or in reference to any one or any combination of some or all of FIGS. 1-10, provided is an apparatus (e.g., 100 or 160, FIG. 1) comprising an optical receiver (e.g., 166, FIGS. 1, 4) configured to receive an optical input signal (e.g., 222′, FIG. 4) modulated with data, wherein the optical receiver comprises: an optical-to-electrical converter configured to: generate a first amplitude-modulated electrical signal (e.g., 710, FIG. 7A) in response to a first amplitude-modulated portion (e.g., 302₁, FIG. 3; 510, FIG. 5A) of the optical input signal, the first amplitude-modulated portion having a first symbol rate (e.g., R₁, FIG. 3); and generate a second amplitude-modulated electrical signal (e.g., 720, FIG. 7B) in response to a second amplitude-modulated portion (e.g., 302₂, FIG. 3; 520, FIG. 5B) of the optical input signal, the second amplitude-modulated portion having a second symbol rate (e.g., R₂, FIG. 3) that is greater than the first symbol rate; and a clock-recovery circuit (e.g., 420, FIG. 4) configured to generate a first clock signal (e.g., 422, FIG. 4) by processing a sequence of said first and second amplitude-modulated electrical signals to phase-align the first clock signal with signal transitions therein.

In some embodiments of the above apparatus, the optical receiver further comprises a signal decoder (e.g., 430, FIG. 4) configured to recover at least some of the data by sampling at least some electrical signals of the sequence at times determined using the first clock signal.

In some embodiments of any of the above apparatus, the signal decoder is configurable (e.g., as indicated in FIGS. 7, 9, 10) to recover said at least some of the data from selected first amplitude-modulated electrical signals of the sequence or from selected second amplitude-modulated electrical signals of the sequence.

In some embodiments of any of the above apparatus, the optical receiver further comprises a frequency multiplier (e.g., 950, FIG. 9) configured to generate a second clock signal (e.g., 952, FIG. 9) by multiplying a frequency of the first clock signal.

In some embodiments of any of the above apparatus, the optical receiver further comprises: a clock-selector switch (e.g., 954, FIG. 9) configured to select one of the first and second clock signals; and a signal decoder (e.g., 430, FIG. 9) configured to recover at least some of the data by sampling at least some electrical signals of the sequence at times determined using the selected one of the first and second clock signals.

In some embodiments of any of the above apparatus, the clock-recovery circuit comprises: a voltage-controlled oscillator (e.g., 830, FIG. 8) configured to change a frequency of the first clock signal in response to an error signal (e.g., 822, FIG. 8); and a phase detector (e.g., 810, FIG. 8) operatively connected to the voltage-controlled oscillator to provide the error signal thereto and configured to generate the error signal based on time differences between the signal transitions in the sequence of said first and second electrical signals and corresponding edges of the first clock signal.

In some embodiments of any of the above apparatus, the clock-recovery circuit further comprises a low-pass filter (e.g., 820, FIG. 8) operatively connected between the phase detector and the voltage-controlled oscillator to cause the error signal to be time-averaged.

In some embodiments of any of the above apparatus, the optical-to-electrical converter is configured to have a low-pass transfer function (e.g., 602, FIG. 6) having a 3-dB attenuation point located between a first frequency and a second frequency, the first and second frequencies being smaller than the second symbol rate or smaller than the first symbol rate.

In some embodiments of any of the above apparatus, the first amplitude-modulated portion comprises a non-return-to-zero (NRZ)-modulated optical signal; the second amplitude-modulated portion comprises another NRZ-modulated optical signal; the first amplitude-modulated electrical signal comprises an NRZ-modulated electrical signal; and the second amplitude-modulated electrical signal comprises a duobinary electrical signal.

According to another example embodiment disclosed above, e.g., in the summary section and/or in reference to any one or any combination of some or all of FIGS. 1-10, provided is an apparatus (e.g., 100 or 160, FIG. 1) comprising an optical receiver (e.g., 166, FIGS. 1, 4) configured to receive an optical input signal (e.g., 222′, FIG. 4) modulated with data, wherein the optical receiver comprises: an optical-to-electrical converter configured to: generate an NRZ-modulated electrical signal (e.g., 710, FIG. 7A) in response to a first NRZ-modulated portion (e.g., 302₁, FIG. 3; 510, FIG. 5A) of the optical input signal, the first NRZ-modulated portion having a first data rate (e.g., R₁, FIG. 3); and generate a duobinary electrical signal (e.g., 720, FIG. 7B) in response to a second NRZ-modulated portion (e.g., 302₂, FIG. 3; 520, FIG. 5B) of the optical input signal, the second NRZ-modulated portion having a second data rate (e.g., R₂, FIG. 3) that is greater than the first data rate; and a clock-recovery circuit (e.g., 420, FIG. 4) configured to generate a first clock signal (e.g., 422, FIG. 4) by processing a sequence of said NRZ-modulated and duobinary electrical signals to phase-align the first clock signal with signal transitions therein.

In some embodiments of the above apparatus, the optical receiver further comprises a signal decoder (e.g., 430, FIG. 4) configured to recover at least some of the data by sampling at least some electrical signals of the sequence at times determined using the first clock signal.

In some embodiments of any of the above apparatus, the signal decoder is configurable (e.g., as indicated in FIGS. 7, 9, 10) to recover said at least some of the data from an NRZ-modulated electrical signal of the sequence or from a duobinary electrical signal of the sequence.

In some embodiments of any of the above apparatus, the second data rate is two times greater than the first data rate.

In some embodiments of any of the above apparatus, the optical receiver further comprises a frequency multiplier (e.g., 950, FIG. 9) configured to generate a second clock signal (e.g., 952, FIG. 9) by multiplying a frequency of the first clock signal.

In some embodiments of any of the above apparatus, the optical receiver further comprises a signal decoder (e.g., 430, FIG. 4) configured to recover at least some of the data by sampling at least some duobinary electrical signals of the sequence at times determined using the second clock signal.

In some embodiments of any of the above apparatus, the optical receiver further comprises: a clock-selector switch (e.g., 954, FIG. 9) configured to select one of the first and second clock signals; and a signal decoder (e.g., 430, FIG. 9) configured to recover at least some of the data by sampling at least some electrical signals of the sequence at times determined using the selected one of the first and second clock signals.

In some embodiments of any of the above apparatus, the frequency multiplier is configured to generate the second clock signal by multiplying the frequency of the first clock signal by a factor of two or four.

In some embodiments of any of the above apparatus, the optical-to-electrical converter is configured to have a low-pass transfer function (e.g., 602, FIG. 6) having a 3-dB attenuation point located between a first frequency and a second frequency, the first and second frequencies being 20% and 40% of the second data rate, respectively.

In some embodiments of any of the above apparatus, the optical-to-electrical converter comprises a bandwidth-limited photodiode configured to have a low-pass transfer function (e.g., 602, FIG. 6) having a 3-dB attenuation point located between a first frequency and a second frequency, the first and second frequencies being 20% and 40% of the second data rate, respectively.

In some embodiments of any of the above apparatus, the clock-recovery circuit comprises: a voltage-controlled oscillator (e.g., 830, FIG. 8) configured to change a frequency of the first clock signal in response to an error signal (e.g., 822, FIG. 8); and a phase detector (e.g., 810, FIG. 8) operatively connected to the voltage-controlled oscillator to provide the error signal thereto and configured to generate the error signal based on time differences between the signal transitions in the sequence of said NRZ-modulated and duobinary electrical signals and corresponding edges of the first clock signal.

In some embodiments of any of the above apparatus, the clock-recovery circuit further comprises a low-pass filter (e.g., 820, FIG. 8) operatively connected between the phase detector and the voltage-controlled oscillator to cause the error signal to be time-averaged.

In some embodiments of any of the above apparatus, the signal transitions include signal transitions (e.g., corresponding to 712, 714, 716, FIG. 7A, and 722, 724, and 726, FIG. 7B) through a normalized signal level of approximately 0.5.

In some embodiments of any of the above apparatus, the apparatus further comprises an optical transmitter (e.g., 112, FIG. 1) optically connected to apply the optical input signal to the optical receiver; wherein the optical transmitter comprises a clock generator (e.g., 230, FIG. 2) configured to generate a master clock signal (e.g., 232, FIG. 2); and wherein the optical transmitter is configured to generate the first and second NRZ-modulated portions of the optical input signal using the master clock signal.

In some embodiments of any of the above apparatus, the apparatus further comprises an optical transmitter (e.g., 112, FIG. 1) and a plurality of additional optical receivers (e.g., 160₁-160_{N}, FIG. 1) connected to the optical transmitter; wherein the optical transmitter is configured to broadcast an optical output signal (e.g., 222, FIG. 2) to the optical receiver and the plurality of additional optical receivers; and wherein the optical output signal so broadcast causes the optical receiver to receive the optical input signal.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The description and drawings merely illustrate the principles of the disclosure. It will thus be appreciated that those of ordinary skill in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of example circuitry embodying the operating principles disclosed herein.

1. An apparatus comprising an optical receiver configured to receive an optical input signal modulated with data, wherein the optical receiver comprises:
an optical-to-electrical converter configured to:
generate a first amplitude-modulated electrical signal in response to a first amplitude-modulated portion of the optical input signal, the first amplitude-modulated portion having a first symbol rate that is a rate of a clock; and
generate a second amplitude-modulated electrical signal in response to a second amplitude-modulated portion of the optical input signal, the second amplitude-modulated portion having a second symbol rate that is greater than the first symbol rate; and
a clock-recovery circuit configured to generate a first clock signal in response to said first amplitude-modulated electrical signal such that said first clock signal frequency locks to the rate of the clock, and to continue to generate said first clock signal in response to said second amplitude-modulated electrical signal such that said first clock signal continues to frequency lock to the rate of the clock.

2. The apparatus of claim 1, wherein the optical receiver further comprises a signal decoder configured to recover at least some of the data by sampling at least some electrical signals of a sequence of the first and second amplitude-modulated electrical signals at times determined using the first clock signal.

3. The apparatus of claim 2, wherein the signal decoder is configurable to recover said at least some of the data from selected first amplitude-modulated electrical signals of the sequence or from selected second amplitude-modulated electrical signals of the sequence.

4. The apparatus of claim 1, wherein the optical receiver further comprises a frequency multiplier configured to generate a second clock signal by multiplying a frequency of the first clock signal.

5. The apparatus of claim 4, wherein the optical receiver further comprises:
a clock-selector switch configured to select one of the first and second clock signals; and
a signal decoder configured to recover at least some of the data by sampling at least some electrical signals of a sequence of the first and second amplitude-modulated electrical signals at times determined using the selected one of the first and second clock signals.

6. The apparatus of claim 1, wherein the clock-recovery circuit comprises:
a voltage-controlled oscillator configured to change a frequency of the first clock signal in response to an error signal; and
a phase detector operatively connected to the voltage-controlled oscillator to provide the error signal thereto and configured to generate the error signal based on time differences between the signal transitions in a sequence of said first and second electrical signals and corresponding edges of the first clock signal.

7. The apparatus of claim 6, wherein the clock-recovery circuit further comprises a low-pass filter operatively connected between the phase detector and the voltage-controlled oscillator to cause the error signal to be time-averaged.

8. The apparatus of claim 1, wherein the optical-to-electrical converter is configured to have a low-pass transfer function having a 3-dB attenuation point located between a first frequency and a second frequency, the first and second frequencies being smaller than the second symbol rate or smaller than the first symbol rate.

9. The apparatus of claim 1, wherein:
the first amplitude-modulated portion comprises a non-return-to-zero (NRZ)-modulated optical signal;
the second amplitude-modulated portion comprises another NRZ-modulated optical signal;
the first amplitude-modulated electrical signal comprises an NRZ-modulated electrical signal; and
the second amplitude-modulated electrical signal comprises a duobinary electrical signal.

10. An apparatus comprising an optical receiver configured to receive an optical input signal modulated with data, wherein the optical receiver comprises:
an optical-to-electrical converter configured to:
generate a non-return-to-zero (NRZ)-modulated electrical signal in response to a first NRZ-modulated portion of the optical input signal, the first NRZ-modulated portion having a first symbol rate that is a rate of a clock; and
generate a duobinary electrical signal in response to a second NRZ-modulated portion of the optical input signal, the second NRZ-modulated portion having a second symbol rate that is greater than the first symbol rate; and
a clock-recovery circuit configured to generate a first clock signal in response to said NRZ-modulated electrical signal such that said first clock signal frequency locks to the rate of the clock, and to continue to generate said first clock signal in response to said duobinary electrical signal such that said first clock signal continues to frequency lock to the rate of the clock.

11. The apparatus of claim 10, wherein the optical receiver further comprises a signal decoder configured to recover at least some of the data by sampling at least some electrical signals of a sequence of the NRZ-modulated and duobinary electrical signals at times determined using the first clock signal.

12. The apparatus of claim 11, wherein the signal decoder is configurable to recover said at least some of the data from an NRZ-modulated electrical signal of the sequence or from a duobinary electrical signal of the sequence.

13. The apparatus of claim 10, wherein the optical receiver further comprises a frequency multiplier configured to generate a second clock signal by multiplying a frequency of the first clock signal.

14. The apparatus of claim 13, wherein the optical receiver further comprises a signal decoder configured to recover at least some of the data by sampling at least some duobinary electrical signals of a sequence of the NRZ-modulated and duobinary electrical signals at times determined using the second clock signal.

15. The apparatus of claim 13, wherein the optical receiver further comprises:
a clock-selector switch configured to select one of the first and second clock signals; and
a signal decoder configured to recover at least some of the data by sampling at least some electrical signals of a sequence of the NRZ-modulated and duobinary electrical signals at times determined using the selected one of the first and second clock signals.

16. The apparatus of claim 13, wherein the frequency multiplier is configured to generate the second clock signal by multiplying the frequency of the first clock signal by a factor of two or four.

17. The apparatus of claim 10, wherein the clock-recovery circuit comprises:
a voltage-controlled oscillator configured to change a frequency of the first clock signal in response to an error signal; and
a phase detector operatively connected to the voltage-controlled oscillator to provide the error signal thereto and configured to generate the error signal based on time differences between the signal transitions in a sequence of the NRZ-modulated and duobinary electrical signals and corresponding edges of the first clock signal.

18. The apparatus of claim 17, wherein the clock-recovery circuit further comprises a low-pass filter operatively connected between the phase detector and the voltage-controlled oscillator to cause the error signal to be time-averaged.

19. The apparatus of claim 10, further comprising an optical transmitter optically connected to apply the optical input signal to the optical receiver;
wherein the optical transmitter comprises a clock generator configured to generate a master clock signal; and
wherein the optical transmitter is configured to generate first and second NRZ-modulated portions of the optical input signal using the master clock signal.

20. The apparatus of claim 10, further comprising an optical transmitter and a plurality of additional optical receivers connected to the optical transmitter; and
wherein the optical transmitter is configured to broadcast an optical output signal to the optical receiver and the plurality of additional optical receivers; and
wherein the optical output signal so broadcast causes the optical receiver to receive the optical input signal.
